(19) United States
(12) Patent Application Publication
(10) Pub. No.: US 2013/0222543 A1
(43) Pub. Date: Aug. 29, 2013

(54) METHOD AND APPARATUS FOR GENERATING DEPTH INFORMATION FROM IMAGE

(71) Applicants: Kwang-Hyuk BAE, SEOUL (KR); Kyu-Min KYUNG, SEOUL (KR); Tae-Chan KIM, YONGIN-SI (KR)

(72) Inventors: Kwang-Hyuk BAE, SEOUL (KR); Kyu-Min KYUNG, SEOUL (KR); Tae-Chan KIM, YONGIN-SI (KR)

(73) Assignee: SAMSUNG ELECTRONICS CO., LTD., SUWON-SI (KR)

(21) Appl. No.: 13/598,824

(22) Filed: Aug. 30, 2012

(30) Foreign Application Priority Data
Feb. 27, 2012 (KR) 10-2012-0019833

(51) Int. Cl. G06K 9/36; H04N 13/02

(52) U.S. Cl. 348/46; 382/285; 348/E13.074

(57) ABSTRACT

An apparatus for generating depth information includes a sensing unit and a final depth providing unit. The sensing unit is configured to sense light received from multiple subjects, and to provide initial depth data having distance information about the subjects and two-dimensional (2D) image data having 2D image information about an image obtained from the subjects. The final depth providing unit is configured to generate estimated depth data having estimated distance information about the subjects by transforming the 2D image data into three-dimensional (3D) data, and to provide final depth data based on the initial depth data and the estimated depth data.

### CROSS-REFERENCE TO RELATED APPLICATIONS

A claim of priority under 35 U.S.C. §119 is made to Korean Patent Application No. 10-2012-0019833, filed on Feb. 27, 2012, in the Korean Intellectual Property Office, the entire contents of which are hereby incorporated by reference.

### BACKGROUND

The inventive concept relates to a photographing apparatus, and more particularly, to an apparatus and method for generating depth information and a photographing apparatus including the same.

Generally, image sensors are devices that convert optical signals, including image or distance information, into electrical signals. Image sensors capable of precisely and accurately providing desired information are being actively researched. The research includes three-dimensional (3D) image sensors for providing distance information, as well as image information.

### SUMMARY

Embodiments of the inventive concept provide an apparatus and a method for generating depth information with greater accuracy through correction than depth data provided from a depth sensor. Embodiments also provide a photographing apparatus including an apparatus for generating depth information with greater accuracy through correction than depth data provided from a depth sensor.

According to an aspect of the inventive concept, there is provided an apparatus for generating depth information, the apparatus including a sensing unit and a final depth providing unit. The sensing unit is configured to sense light received from multiple subjects, and to provide initial depth data having distance information about the subjects and two-dimensional (2D) image data having 2D image information about an image obtained from the subjects. The final depth providing unit is configured to generate estimated depth data having estimated distance information about the subjects by transforming the 2D image data into three-dimensional (3D) data, and to provide final depth data based on the initial depth data and the estimated depth data.

The final depth providing unit may further divide the image into a first area and a second area, and provide the final depth data by combining the initial depth data of the first area with the estimated depth data of the second area. The first area may include a foreground of at least one main subject from among the multiple subjects. The second area may include a background excluding the at least one main subject from among the multiple subjects.

The final depth providing unit may include a first segmentation unit, a transformation unit, an extraction unit, and a combining unit. The first segmentation unit may be configured to divide the image into multiple segments, and to classify the segments into a first area and a second area based on the initial depth data. The transformation unit may be configured to generate the estimated depth data by transforming the 2D image data into the 3D data. The extraction unit may be configured to extract first data corresponding to the first area from the initial depth data, and to extract second data corresponding to the second area from the estimated depth data. The combining unit may be configured to provide the final depth data by combining the first data with the second data.

The transformation unit may include a second segmentation unit, an indexing unit and a depth map generating unit. The second segmentation unit may be configured to divide the image into multiple segments based on a depth cue in the image. The indexing unit may be configured to index depths of the segments based on the initial depth data. The depth map generating unit may be configured to generate a depth map from the indexed depths of the segments. The transformation unit may further including an estimated depth providing unit configured to provide the estimated depth data that is the 3D data based on the depth map.

The 2D image data may include at least one of intensity data and color data.

The sensing unit may include a depth sensor configured to generate the initial depth data and intensity data based on reflected light received from the subjects. Or, the sensing unit may include a depth sensor configured to generate the initial depth data and intensity data based on reflected light received from the subjects, and a color sensor configured to generate color data based on visible light received from the subjects. The sensing unit may include a depth/color sensor configured to simultaneously generate the initial depth data, intensity data, and color data based on reflected light and visible light received from the subjects. The sensing unit may include a time-of-flight (ToF) sensor for providing the initial depth data.

According to another aspect of the inventive concept, there is provided a photographing apparatus, including an image sensor and a processor. The image sensor includes a sensing unit and a final depth providing unit. The sensing unit is configured to sense light received from multiple subjects, and to provide initial depth data having distance information about the subjects and two-dimensional (2D) image data having 2D image information about an image obtained from the subjects. The final depth providing unit is configured to generate estimated depth data having estimated distance information about the subjects by transforming the 2D image data into three-dimensional (3D) data, and to provide final depth data based on the initial depth data and the estimated depth data.

The final depth providing unit may be further configured to divide the image into a first area and a second area, and to provide the final depth data by combining the initial depth data of the first area with the estimated depth data of the second area.

The final depth providing unit may include a first segmentation unit, a transformation unit, an extracting unit, and a combining unit. The first segmentation unit may be configured to divide the image into multiple segments, and to classify the segments into a first area and a second area based on the initial depth data. The transformation unit may be configured to generate the estimated depth data by transforming the 2D image data into 3D data. The extracting unit may be configured to extract first data corresponding to the first area from the initial depth data, and to extract second data corresponding to the second area from the estimated depth data. The combining unit may be configured to provide the final depth data by combining the first data with the second data.

The 2D image data may include at least one of intensity data and color data.

According to another aspect of the inventive concept, there is provided a method of generating depth information about multiple subjects in an image. The method includes sensing light received from the subjects at a sensing unit; providing initial depth data and two-dimensional (2D) image data based on the sensed light received from the, the initial depth data including distance information; dividing the image into segments, and classifying the segments into a first area and a second area based on the initial depth data; generating estimated depth data based on the 2D image data; extracting first data corresponding to the first area from the initial depth data; extracting second data corresponding to the second area from the estimated depth data; and combining the first data and the second data to provide final depth data.

The 2D image data may include intensity data, and generating the estimated depth data may include transforming the intensity data into 3D data. The intensity data may include two-dimensional black-and-white image information about the subjects. The 2D image data may include color data from the received light, and generating the estimated depth data may include transforming the color data into 3D data.

The first area and the second area may include a foreground and a background of the image, respectively.

### BRIEF DESCRIPTION OF THE DRAWINGS

Illustrative embodiments will be more clearly understood from the following detailed description taken in conjunction with the accompanying drawings, in which:

FIG. 1 is a block diagram illustrating an apparatus for generating depth information, according to an embodiment of the inventive concept;

FIG. 2 is a block diagram illustrating the apparatus of FIG. 1, according to an embodiment of the inventive concept;

FIG. 3 is a diagram illustrating an example of areas obtained by a first segmentation unit of the apparatus of FIG. 2, according to an embodiment of the inventive concept;

FIG. 4 is a block diagram illustrating an apparatus for generating depth information, which is a modification of the apparatus of FIG. 2, according to an embodiment of the inventive concept.

FIG. 5 is a block diagram illustrating a depth sensor of the apparatus of FIG. 4, according to an embodiment of the inventive concept;

FIG. 6 is a graph illustrating a case in which distance between the depth sensor and a subject group is calculated, according to an embodiment of the inventive concept;

FIG. 7 is a block diagram illustrating an apparatus for generating depth information, which is another modification of the apparatus of FIG. 2, according to an embodiment of the inventive concept;

FIG. 8 is a block diagram illustrating a color sensor of the apparatus of FIG. 7, according to an embodiment of the inventive concept;

FIG. 9 is a block diagram illustrating an apparatus for generating depth information, which is another modification of the apparatus of FIG. 2, according to an embodiment of the inventive concept;

FIG. 10 is a block diagram illustrating a depth/color sensor of the apparatus of FIG. 9, according to an embodiment of the inventive concept;

FIG. 11 is a block diagram illustrating a transformation unit which is a modification of a transformation unit of the apparatus of FIG. 2, according to an embodiment of the inventive concept;

FIGS. 12A through 12C are examples of estimated depth data provided by the transformation unit of FIG. 11, according to an embodiment of the inventive concept;

FIGS. 13A through 13D are examples of images illustrating results output from elements included in the transformation unit of FIG. 11, according to an embodiment of the inventive concept;

FIGS. 14A through 14D are examples of images for explaining operation of a final depth providing unit of the apparatus of FIG. 2, according to an embodiment of the inventive concept;

FIG. 15 is a flowchart illustrating a method of generating depth information, according to an embodiment of the inventive concept;

FIG. 16 is a flowchart illustrating a method of generating depth information, according to another embodiment of the inventive concept;

FIG. 17 is a flowchart illustrating a method of generating depth information, according to another embodiment of the inventive concept;

FIG. 18 is a block diagram illustrating a photographing apparatus including an apparatus for generating depth information, according to an embodiment of the inventive concept;

FIG. 19 is a block diagram illustrating a computing system including the photographing apparatus of FIG. 18, according to an embodiment of the inventive concept; and

FIG. 20 is a block diagram illustrating an interface used in the computing system of FIG. 19, according to an embodiment of the inventive concept.

### DETAILED DESCRIPTION OF THE EMBODIMENTS

Embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. Accordingly, known processes, elements, and techniques are not described with respect to some of the embodiments of the inventive concept. Unless otherwise noted, like reference numerals denote like elements throughout the attached drawings and written description, and thus descriptions will not be repeated. In the attached drawings, sizes of structures may be exaggerated for clarity.

As used herein, the term “and/or” includes any and all combinations of one or more of the associated listed items. Expressions such as “at least one of,” when preceding a list of elements, modify the entire list of elements and do not modify the individual elements of the list. Also, the term “exemplary” is intended to refer to an example or illustration.

The terminology used herein is for the purpose of describing particular embodiments only and is not intended to be limiting of exemplary embodiments of the inventive concept. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It will be understood that, although the terms first, second, third etc. may be used herein to describe various elements, components, regions, layers, and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of exemplary embodiments.

Unless otherwise defined, all terms (including technical and scientific terms) used herein have the same meaning as commonly understood by one of ordinary skill in the art to which exemplary embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

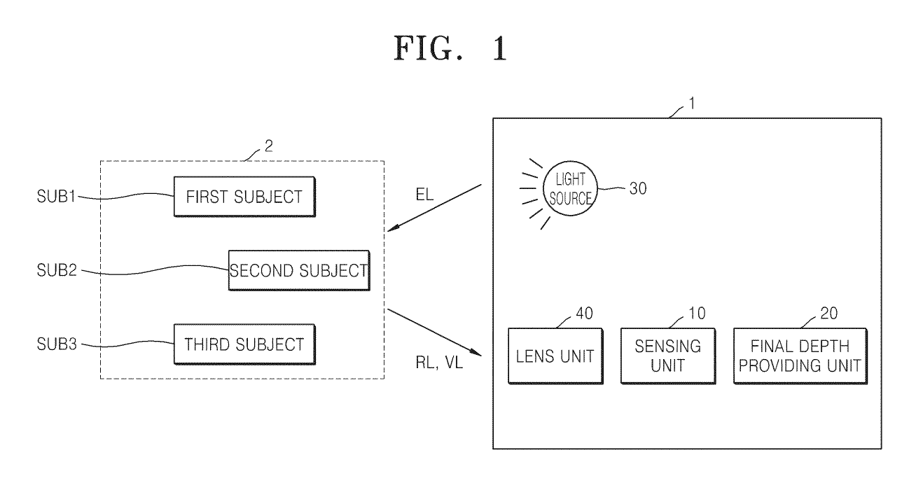

FIG. 1 is a block diagram illustrating an apparatus for generating depth information, according to an embodiment of the inventive concept.

Referring to FIG. 1, apparatus 1 includes a sensing unit 10 and a final depth providing unit 20. The apparatus 1 may further include a light source 30 and a lens unit 40. For purposes of illustration, subject group 2 includes multiple subjects, indicated as representative first through third subjects SUB1, SUB2 and SUB3. Distances between the apparatus 1 and the first through third subjects SUB1, SUB2 and SUB3 may be different from one another. Of course, the number of the subjects included in the subject group 2 is not limited to three, and may include fewer or more than three subjects.

The light source 30 generates light EL having a predetermined wavelength, for example, infrared light or near-infrared light, and emits the light EL to the first through third subjects SUB1, SUB2 and SUB3. The light source 30 may be a light-emitting diode (LED) or a laser diode, for example. The light source 30 may be implemented as a device separate from the sensing unit 10, or alternatively, the light source 30 may be implemented such that at least a portion of the light source 30 is included in the sensing unit 10.

The light EL may be controlled by, for example, a control unit (not shown) included in the sensing unit 10, so that intensity (the number of photons per unit area) may periodically change. For example, the intensity of the light EL may be controlled to have a waveform, such a sine wave, a cosine wave, or a pulse wave having continuous pulses, or the like.

The lens unit 40 may include at least one lens (not shown), and concentrate light received from the first through third subjects SUB 1, SUB2 and SUB3, particularly including reflected light RL and/or visible light VL, onto light-receiving areas of the sensing unit 10. For example, distance pixels and/or color pixels formed in pixel arrays (not shown) may be included in the sensing unit 10. In various embodiments, the lens unit 40 may include multiple lenses, and the number of lenses may correspond to the number of sensors (not shown) included in the sensing unit 10. In this case, the lenses may be arranged in various shapes on the same plane. For example, the lenses may be aligned in a horizontal direction or a vertical direction, or arranged in a matrix of rows and columns. Alternatively, the lens unit 40 may include one lens and one or more prisms (not shown), and the number of prisms may correspond to the number of sensors included in the sensing unit 10.

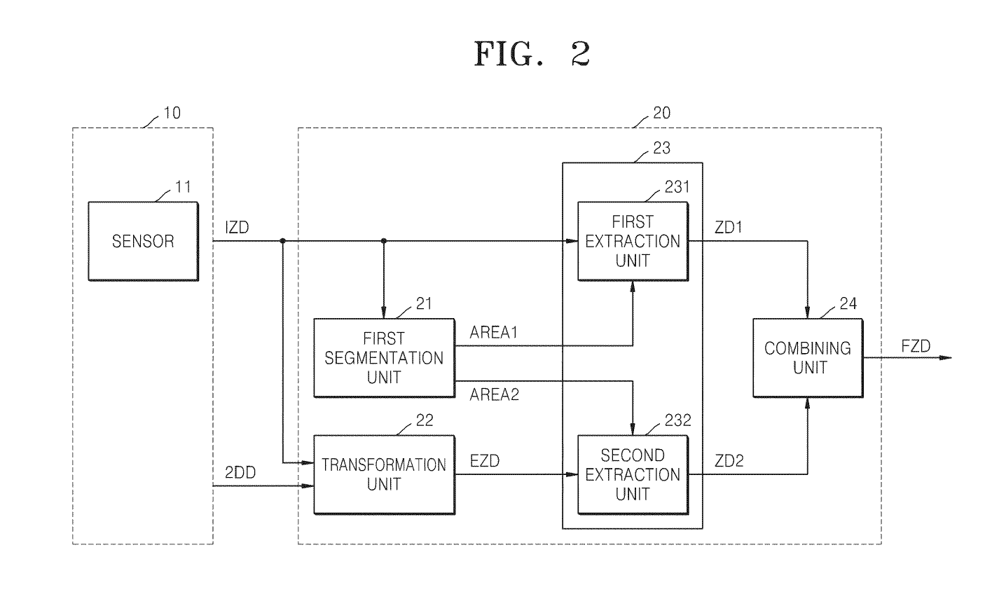

FIG. 2 is a block diagram illustrating the apparatus 1 of FIG. 1, according to an embodiment of the inventive concept.

Referring to FIG. 2, the sensing unit 10 includes one or more sensors, indicated by representative sensor 11. The final depth providing unit 20 includes a first segmentation unit 21, a transformation unit 22, an extraction unit 23, and a combining unit 24. Structure and operation of the sensing unit 10 and the final depth providing unit 20 will be explained in detail with reference to FIGS. 1 and 2.

The sensing unit 10 senses the reflected light RL and/or the visible light VL concentrated by the lens unit 40. In particular, the sensor 11 included in the sensing unit 10 senses the reflected light RL and/or the visible light VL, and provides initial depth data IZD and two-dimensional (2D) image data 2DD.

The initial depth data IZD includes distance information about the first through third subjects SUB1, SUB2 and SUB3, and the 2D image data 2DD includes 2D image information about an image obtained from the first through third subjects SUB1, SUB2 and SUB3. The initial depth data IZD varies according to distances between the sensing unit 10 and the first through third subjects SUB1, SUB2 and SUB3, whereas the 2D image data 2DD is not related to the distances between the sensing unit 10 and the first through third subjects SUB1, SUB2 and SUB3.

A maximum distance that the sensing unit 10 is able to measure may be determined according to a modulation frequency of the light EL emitted by the light source 30. For example, when the modulation frequency of the light EL is 30 MHz, the sensing unit 10 may measure a maximum distance of 5 m from the sensing unit 10. However, at least one of the first through third subjects SUB1, SUB2, and SUB3 may be located beyond the maximum distance of 5 m from the sensing unit 10. For example, a distance between the sensing unit 10 and the first subject SUB1 from among the first through third subjects SUB1, SUB2, and SUB3 may be 7 m, in which case the sensing unit 10 may measure a distance between the first subject SUB1 and the sensing unit 10 as 2 m, due to a phenomenon referred to as depth folding.

As such, when a distance between the sensing unit 10 and any of the first through third subjects SUB1, SUB2, and SUB3 is relatively large, for example, when the distance between the sensing unit 10 and any of the first through third subjects SUB1, SUB2, and SUB3 is greater than the maximum distance that the sensing unit 10 is able to measure, the sensing unit 10 may not provide accurate distance information. In other words, when a distance between the sensing unit 10 and any of the first through third subjects SUB1, SUB2, and SUB3 is relatively large, for example, in a background of an image, the initial depth data IZD may have an inaccurate value. An example of a relatively large distance between the sensing unit 10 and any of the first through third subjects SUB1, SUB2, and SUB3 is in a background of the image.

In an embodiment, the final depth providing unit 20 generates estimated depth data EZD by transforming the 2D image data 2DD into 3D data, and provides final depth data FZD based on the initial depth data IZD and the estimated depth data EZD. The estimated depth data EZD may have estimated distance information about the first through third subjects SUB1, SUB2, and SUB3. Also, the final depth data FZD may have corrected depth information, that is, depth information with greater accuracy and realistic visual effect about the first through third subjects SUB1, SUB2, and SUB3 than the initial depth data IZD.

The first segmentation unit 21 of the final depth providing unit 20 divides an image into multiple segments, and classifies the segments into a first area AREA1 and a second area AREA2 based on the initial depth data IZD. For example, the first area AREA1 may include a foreground of at least one main subject to be focused from among the first through third subjects SUB1, SUB2, and SUB3, and the second area AREA2 may include a background excluding the at least one main subject from among the first through third subjects SUB1, SUB2, and SUB3.

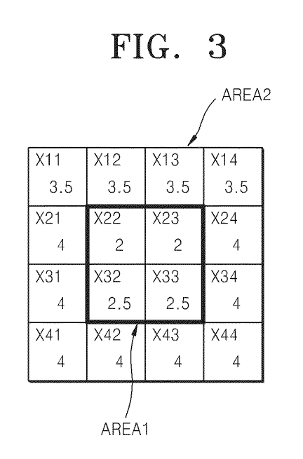

FIG. 3 is a diagram illustrating an example of areas obtained by the first segmentation unit 21 of the apparatus 1 of FIG. 2, according to an embodiment of the inventive concept.

Referring to FIG. 3, the first segmentation unit 21 divides an image into 16 segments X11-X14, X21-X24, X31-X34 and X41-X44. Although 16 segments are exemplarily shown in FIG. 3, the first segmentation unit 21 may divide an image into more or fewer segments than 16 segments, without departing from the scope of the present teachings.

The first segmentation unit 21 may classify the 16 segments into two areas, for example, the first area AREA1 and the second area AREA2, based on the initial depth data IZD. The first segmentation unit 21 may classify an area having a relatively small distance between the sensing unit 10 and the first through third subjects SUB1, SUB2, and SUB3 as the first area AREA1, and an area having a relatively large distance between the sensing unit 10 and the first through third subjects SUB1, SUB2, and SUB3 as the second area AREA2.

More particularly, in the depicted example, the first segmentation unit 21 determines that the segments X22, X23, X32 and X33, each of which has initial depth data IZD lower than a threshold value (e.g., 3), are to be included in the first area AREA1. The first segmentation unit 21 further determines that the segments X11-X14, X21, X24, X31, X34 and X41-X44, each of which has initial depth data IZD greater than the threshold value (e.g., 3), are to be included in the second area AREA2. The determinations are made based on the initial depth data IZD of the 16 segments X11-X14, X21-X24, X31-X34 and X41-X44.

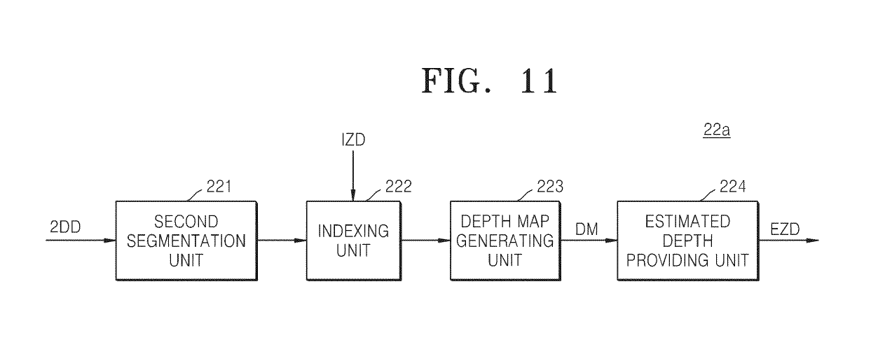

Referring again to FIG. 2, the transformation unit 22 generates the estimated depth data EZD by transforming the 2D image data 2DD into three-dimensional (3D) data. Structure and operation of the transformation unit 22 will be explained below in detail with reference to FIG. 11.

The extraction unit 23 includes first and second extraction units 231 and 232. The first extraction unit 231 extracts first data ZD1 corresponding to the first area AREA1 from the initial depth data IZD, and the second extraction unit 232 extracts second data ZD2 corresponding to the second area AREA2 from the estimated depth data EZD. For example, the first extraction unit 231 may extract the first data ZD1 corresponding to a foreground from the initial depth data IZD, and the second extraction unit 232 may extract the second data ZD2 corresponding to a background from the estimated depth data EZD.

The combining unit 24 provides the final depth data FZD by combining the first data ZD1 and the second data ZD2. When reflectivity of a subject included in the foreground is relatively low, for example, the initial depth data IZD of the subject provided by the sensing unit 10 may not be accurate. In this case, the final depth data FZD, having greater accuracy through correction than the initial depth data IZD, may be generated based on the 2D image data 2DD generated by the sensing unit 10. Thus, according to the present embodiment, since the initial depth data IZD provided by the sensing unit 10 is combined with the estimated depth data EZD generated from the 2D image data 2DD provided by the sensing unit 10, the final depth data FZD has greater accuracy and realistic visual effect through correction than the initial depth data IZD.

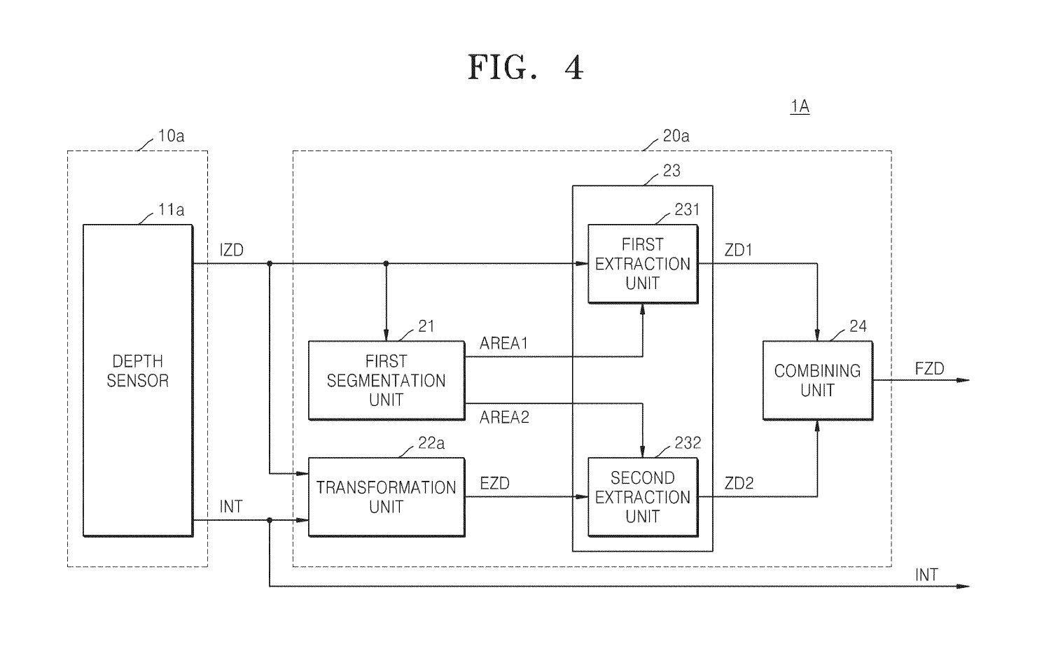

FIG. 4 is a block diagram illustrating an apparatus 1A for generating depth information, which is a modification of the apparatus 1 of FIG. 2, according to an embodiment of the inventive concept.

Referring to FIG. 4, the apparatus 1A includes a sensing unit 10a and a final depth providing unit 20a. The sensing unit 10a includes one or more depth sensors, indicated by representative depth sensor 11a. The depth sensor 11a provides the initial depth data IZD and intensity data INT based on the reflected light RL received from the first through third subjects SUB1, SUB2, and SUB3. The depth sensor 11a may include a time-of-flight (ToF) sensor, for example.

The initial depth data IZD indicates a distance between the apparatus 1A and any of the first through third subjects SUB1, SUB2, and SUB3, providing perspective. Since the intensity data INT is measured using an intensity of light reflected and/or refracted from the first through third subjects SUB1, SUB2, and SUB3, the first through third subjects SUB1, SUB2, and SUB3 may be distinguished from one another using the intensity data INT. For example, the intensity data INT may have 2D black-and-white image information, such as offset or amplitude, about the first through third subjects SUB1, SUB2, and SUB3.

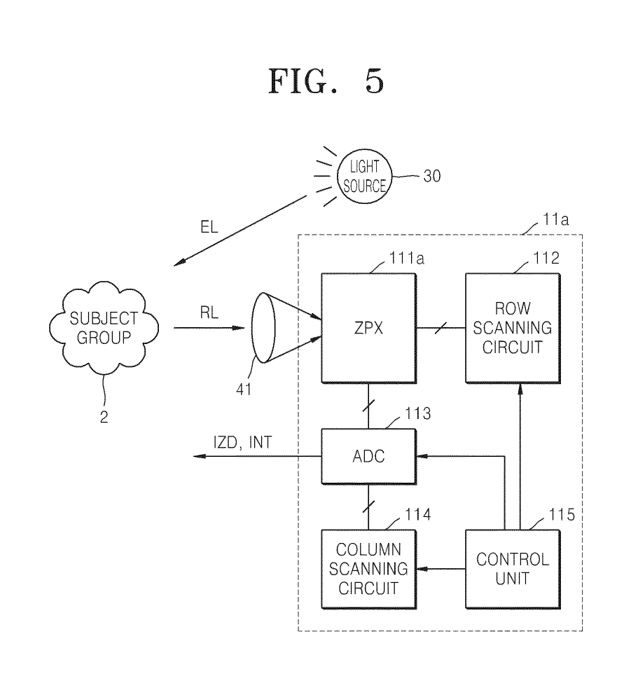

FIG. 5 is a block diagram illustrating the depth sensor 11a of the apparatus 1A of FIG. 4, according to an embodiment of the inventive concept.

Referring to FIG. 5, the depth sensor 11a includes a depth pixel array 111a, a row scanning circuit 112, an analog-to-digital conversion (ADC) unit 113, a column scanning circuit 114, and a control unit 115.

A light-receiving lens 41 concentrates the reflected light RL onto the depth pixel array 111a. The reflected light RL is obtained after the light EL emitted by the light source 30 is reflected from the subject group 2, for example.

The depth pixel array 111a may include depth pixels (not shown) that convert the reflected light RL concentrated by the light-receiving lens 41 into electrical signals. The depth pixel array 111a may provide distance information between the depth sensor 11a and the subject group 2 and 2D black-and-white image information, such as offset or amplitude, about the subject group 2.

The row scanning circuit 112 controls row address and row scanning of the depth pixel array 111a by receiving control signals from the control unit 115. In order to select a corresponding row line from among multiple row lines, the row scanning circuit 112 may apply a signal for activating the corresponding row line to the depth pixel array 111a. The row scanning circuit 112 may include a row decoder that selects a row line in the depth pixel array 111a and a row driver that applies a signal for activating the selected row line.

The ADC unit 113 provides the initial depth data IZD and the intensity data INT by converting an analog signal, such as distance information and 2D black-and-white image information output from the depth pixel array 111a, into a digital signal. The ADC unit 113 may perform column ADC that converts analog signals in parallel using an analog-to-digital converter connected to each of column lines. Alternatively, the ADC unit 13 may perform single ADC that sequentially converts analog signals using a single analog-to-digital converter.

According to embodiments, the ADC unit 113 may include a correlated double sampling (CDS) unit (not shown) for extracting an effective signal component. The CDS unit may perform analog double sampling that extracts an effective signal component based on a difference between an analog reset signal that represents a reset component and an analog data signal that represents a signal component. Alternatively, the CDS unit may perform digital double sampling that converts an analog reset signal and an analog data signal into two digital signals and then extracts a difference between the two digital signals as an effective signal component. Alternatively, the CDS unit may perform dual correlated double sampling that performs both analog double sampling and digital double sampling.

The column scanning circuit 114 controls column address and column scanning of the depth pixel array 111a by receiving control signals from the control unit 115. The column scanning circuit 114 may output a digital output signal output from the ADC unit 113 to a digital signal processing circuit (not shown) or an external host (not shown). For example, the column scanning circuit 114 may sequentially select multiple analog-to-digital converters in the ADC unit 113 by outputting a horizontal scanning control signal to the ADC unit 113. The column scanning circuit 14 may include a column decoder that selects one from among the multiple analog-to-digital converters and a column driver that applies an output of the selected analog-to-digital converter to a horizontal transmission line. In this case, the horizontal transmission line may have a bit width for outputting the digital output signal.

The control unit 115 is configured to control the row scanning circuit 112, the ADC unit 113, the column scanning circuit 114, and the light source 30. More particularly, the control unit 115 may apply control signals, such as a clock signal and a timing control signal, to operate the row scanning circuit 112, the ADC unit 113, the column scanning circuit 114, and the light source 30. The control unit 115 may include a logic control circuit, a phase lock loop (PLL) circuit, a timing control circuit, and a communication interface circuit, for example. Alternatively, a function of the control unit 115 may be performed in a processor, such as a separate engine unit.

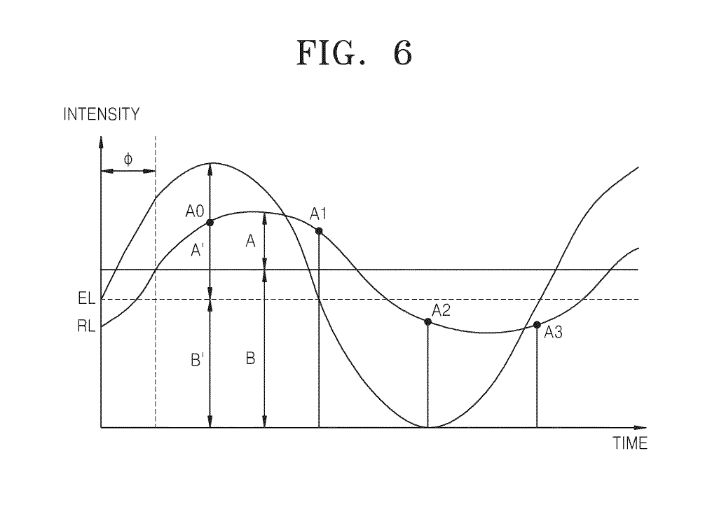

FIG. 6 is a graph illustrating an example in which a distance between the depth sensor 11a and the subject group 2 is calculated, according to an embodiment of the inventive concept.

Referring to FIG. 6, the X-axis represents time and the Y-axis represents intensity. For convenience of explanation, FIG. 6 will be explained using an example in which a distance between the depth sensor 11a and the subject group 2 is calculated based on the reflected light RL received from one of the first through third subjects SUB1, SUB2, and SUB3 in the subject group 2.

Referring to FIGS. 4 through 6, the light EL emitted by the light source 30 may have an intensity that varies periodically. For example, the intensity of the light EL may vary over time in a waveform, like a sine wave.

The light EL emitted by the light source 30 may be incident on the depth pixel array 111a included in the depth sensor 11a as the reflected light RL by being reflected by the subject group 2. The depth pixel array 111a may periodically sample the reflected light RL. According to various embodiments, the depth pixel array 111a may sample the reflected light RL at two sampling points having a phase difference of 180 degrees therebetween in each cycle of the reflected light RL (that is, every cycle of the light EL), at four sampling points having a phase difference of 90 degrees therebetween, or at more sampling points. For example, the depth pixel array 111a may extract samples of the reflected light RL at phases of 90, 180, 270, and 360 degrees of the light EL in each cycle.

The reflected light RL has an offset B different from an offset B′ of the light EL emitted by the light source 30 due to additional background light or noise. The offset B of the reflected light RL may be calculated by using Equation 1, in which A0 indicates an intensity of the reflected light RL sampled at a phase of 90 degrees of the light EL, A1 indicates an intensity of the reflected light RL sampled at a phase of 180 degrees of the light EL, A2 indicates an intensity of the reflected light RL sampled at a phase of 270 degrees of the light EL, and A3 indicates an intensity of the reflected light RL sampled at a phase of 360 degrees of the light EL.

$$B = \frac{A 0 + A 1 + A 2 + A 3}{4} \qquad ( 1 )$$

Also, the reflected light RL has an amplitude A less than an amplitude A′ of the light EL emitted by the light source 30 due to light loss. The amplitude A of the reflected light RL may be calculated by using Equation 2.

$$A = \frac{\sqrt{{( A 0 - A 2 )}^{2} + {( A 1 - A 3 )}^{2}}}{2} \qquad ( 2 )$$

Two dimensional (2D) black-and-white image information about the subject group 2 may be provided based on the amplitude A of the reflected light RL for each of distance pixels included in the depth pixel array 111a.

The reflected light RL is delayed by a phase difference φ between the reflected light RL and the light EL, which is two times the distance between the depth sensor 11a and the subject group 2, from the light EL. The phase difference φ between the reflected light RL and the light EL may be calculated by using Equation 3.

$$φ = arc tan ( \frac{A 0 - A 2}{A 1 - A 3} ) \qquad ( 3 )$$

The phase difference φ between the reflected light RL and the light EL corresponds to a TOF of light. The distance between the depth sensor 11a and the subject group 2 may be calculated by using Equation 4, in which R indicates a distance between the depth sensor 11a and the subject group 2 and c indicates a speed of light.

R=c*TOF/2 (4)

Also, the distance R between the depth sensor 11a and the subject group 2 may be calculated using Equation 5 based on the phase difference φ of the reflected light RL, in which f indicates a modulation frequency, that is, the frequency of the light EL (or the reflected light RL).

$$R = \frac{c}{4 π f} ϕ \qquad ( 5 )$$

Although the depth sensor 11a uses the light EL modulated to have a waveform like a sine wave in FIG. 6, the depth sensor 11a may use the light EL modulated to have any of various waveforms, according to various embodiments. Also, the depth sensor 11a may extract distance information in various ways according to wavelength of the light EL, structures of distance pixels, and the like.

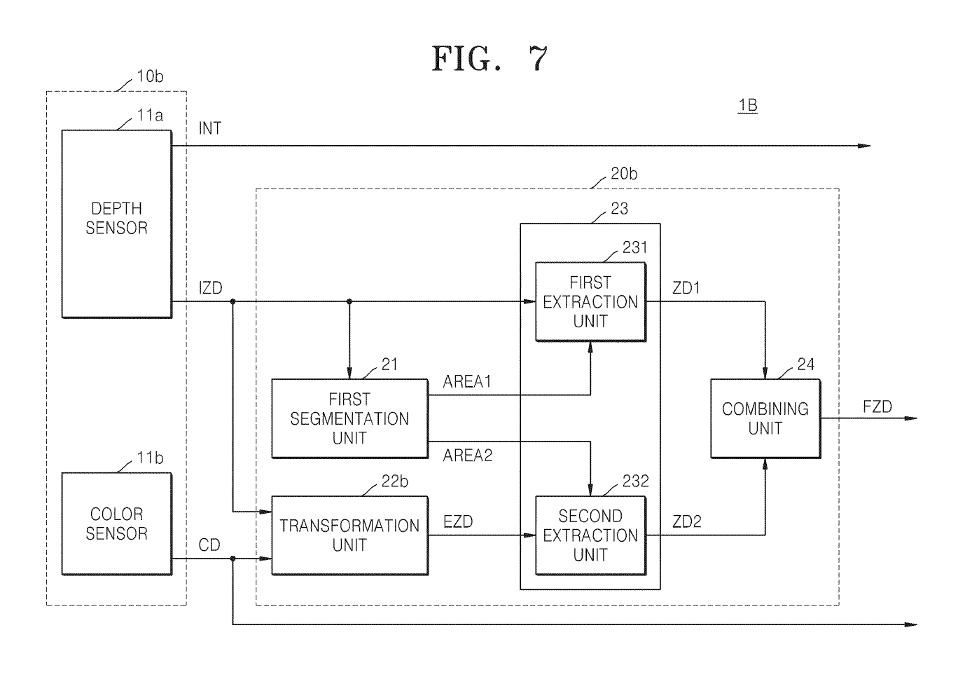

FIG. 7 is a block diagram illustrating an apparatus 1B for generating depth information, which is another modification of the apparatus 1 of FIG. 2, according to an embodiment of the inventive concept.

Referring to FIG. 7, the apparatus 1B include a sensing unit 10b and a final depth providing unit 20b. The sensing unit 10b includes one or more depth sensors, indicated by representative depth sensor 11a, and one or more color sensors, indicated by representative color sensor 11b. The depth sensor 11a generates the initial depth data IZD and the intensity data INT based on the reflected light RL received from the subject group 2. In this case, the depth sensor 1 la may be constructed as shown in FIG. 5, for example. The color sensor 11b generates color data CD of the subject group 2 based on the visible light VL received from the subject group 2. The color data CD may have 2D color image information, such as RGB, about the subject group 2.

When reflectivity of a subject included in a foreground is relatively low, the initial depth data IZD of the subject provided by the depth sensor 11a may not be accurate. In this case, according to the inventive concept, the final depth data FZD, having greater accuracy through correction than the initial depth data IZD, may be generated based on the color data CD generated by the color sensor 11b.

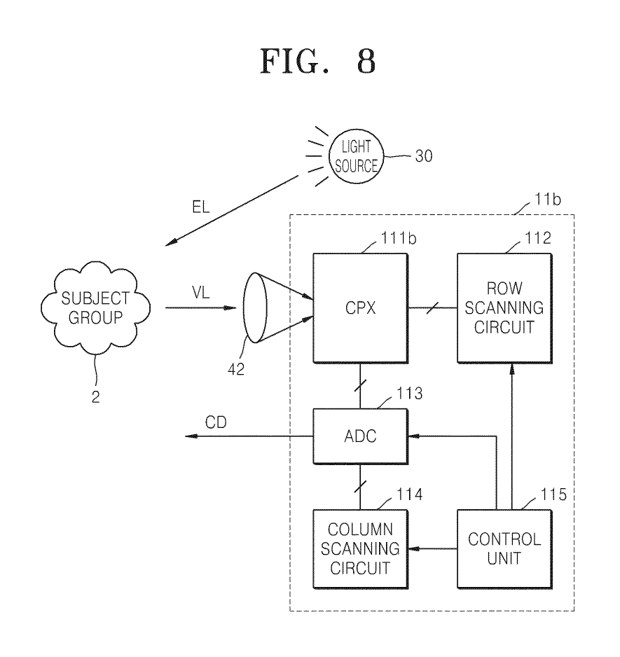

FIG. 8 is a block diagram illustrating the color sensor 11b of the apparatus 1B of FIG. 7, according to an embodiment of the inventive concept.

Referring to FIG. 8, the color sensor 11b includes a color pixel array 111b, the row scanning circuit 112, the ADC unit 113, the column scanning circuit 114, and the control unit 115. The color sensor 11b has substantially the same structure as that of the depth sensor 11a of FIG. 5, except for the color pixel array 111b in place of the depth pixel array 111a. Accordingly, a detailed explanation of the row scanning circuit 112, the ADC unit 113, the column scanning circuit 114, and the control unit 115 will not be repeated.

A light-receiving lens 42 concentrates the visible light VL received from the subject group 2 onto the color pixel array 111b. The color pixel array 111b may include color pixels (not shown) that convert the visible light VL concentrated by the light-receiving lens 42 into electrical signals. The color pixel array 111b may provide 2D color image information, such as RGB, about the first through third subjects SUB1, SUB2, and SUB3.

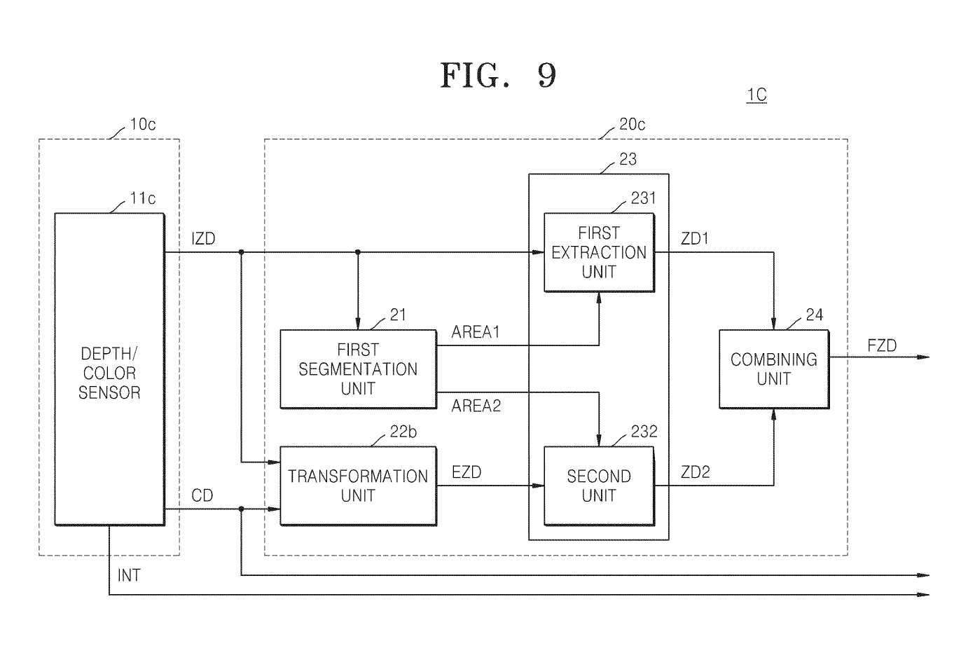

FIG. 9 is a block diagram illustrating an apparatus 1C for generating depth information, which is another modification of the apparatus 1 of FIG. 2, according to an embodiment of the inventive concept.

Referring to FIG. 9, the apparatus 1C includes a sensing unit 10c and a final depth providing unit 20c. The sensing unit 10c includes one or more depth/color sensors, indicated by representative depth/color sensor 11c. The depth/color sensor 11c simultaneously generates the initial depth data IZD and the intensity data INT based on the reflected light RL received from the subject group 2, as well as the color data CD of the subject group 2 based on the visible light VL received from the subject group 2. The color data CD may have 2D color image information, such as RGB, about the subject group 2.

When reflectivity of a subject included in a foreground is relatively low, the initial depth data IZD of the subject provided by the depth/color sensor 11c may not be accurate. In this case, according to the inventive concept, the final depth data FZD having greater accuracy through correction than the initial depth data IZD may be generated based on the color data CD generated by the depth/color sensor 11c.

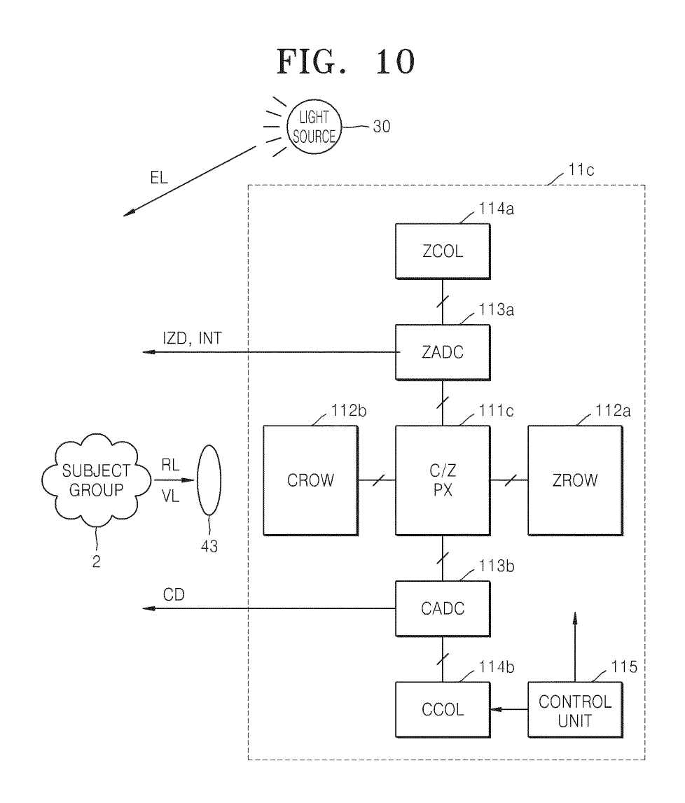

FIG. 10 is a detailed block diagram illustrating the depth/color sensor 11c of the apparatus 1C of FIG. 9, according to an embodiment of the inventive concept.

Referring to FIG. 10, the depth/color sensor 11c includes a depth/color pixel array 111c, depth pixel selection circuits 112a and 114a, color pixel selection circuits 112b and 114b, a depth pixel ADC converter 113a, a color pixel ADC converter 113b, and the control unit 115.

A light-receiving lens 43 concentrates the reflected light RL and the visible light VL received from the subject group 2 onto the depth/color pixel array 111c. The reflected light RL is obtained after the light EL emitted by the light source is reflected from the subject group 2.

The depth/color pixel array 111c may include multiple depth pixels that convert the reflected light RL concentrated by the light-receiving lens 43 into electrical signals, and multiple color pixels that convert the visible light VL concentrated by the light-receiving lens 43 into electrical signals. The depth/color pixel array 111c provides distance information between the depth sensor 11a and the subject group 2, 2D black-and-white image information (e.g., offset or amplitude) about the subject group 2, and 2D color image information (e.g., RGB) about the subject group 2.

The color pixel selection circuits 112b and 114b and the color pixel converter 113b provide the color data CD by controlling color pixels in the pixel array 111c, and the depth pixel selection circuits 112a and 114a and the depth pixel converter 113a provide depth information ZD by controlling distance pixels in the pixel array 111c. The control unit 115 is configured to control the color pixel selection circuits 112b and 114b, the depth pixel selection circuits 112a and 114a, the color pixel converter 113b, and the depth pixel converter 113a.

As such, in order to provide the color data CD, the initial depth data IZD, and the intensity data INT of an image, the sensor unit 11c may include elements for controlling color pixels and elements for controlling distance pixels, which are separately provided and independently operated.

FIG. 11 is a block diagram illustrating a transformation unit 22 of FIG. 2, according to an embodiment of the inventive concept.

Referring to FIG. 11, the transformation unit 22 may include a second segmentation unit 221, an indexing unit 222, a depth map (DM) generating unit 223, and an estimated depth providing unit 224.

The second segmentation unit 221 divided an image, that is, the 2D image data 2DD, into multiple segments based on a depth cue in the image. The second segmentation unit 221 may classify an image into two or more areas based on a depth cue in the image and divide one of the areas into multiple segments. For example, the second segmentation unit 221 may classify an image into two areas, e.g., a foreground and a background, through subject segmentation, and divide the foreground into multiple foreground segments.

The term depth cue refers to any of various types of information indicating a depth. Relative positions of objects in a visible space may be perceived by using the depth cue. For example, a depth cue may include at least one selected from the group consisting of a defocus using a second Gaussian derivative, a linear perspective using vanishing line detection and gradient plane assignment, atmospheric scattering using a light scattering model, shading using energy minimization, a patterned texture using a frontal texel (texture element), symmetric patterns using a combination of photometric and geometric constraints, an occlusion including a curvature using a smoothing curvature and an isophote line and a single transform using a shortest path, and statistical patterns using color-based heuristics and statistical estimators.

The indexing unit 222 indexes depths of the segments based on the initial depth data IZD. More particularly, the indexing unit 222 may index relative depths of the segments based on the initial depth data IZD using the initial depth data IZD as a reference value. As such, the indexing unit 222 may index relative depths of the segments based on a subject having a known initial depth from among the first through third subjects SUB1, SUB2, and SUB3 in the image.

The DM generating unit 223 generates a DM from the indexed depths of the segments. The term DM refers to image information about a 3D distance between a surface of an object and a viewpoint at each pixel in computer graphics.

The estimated depth providing unit 224 provides the estimated depth data EZD that is 3D data based on the DM. More particularly, the estimated depth providing unit 224 may provide image information in the DM as the estimated depth data EZD of the first through third subjects SUB1, SUB2, and SUB3.

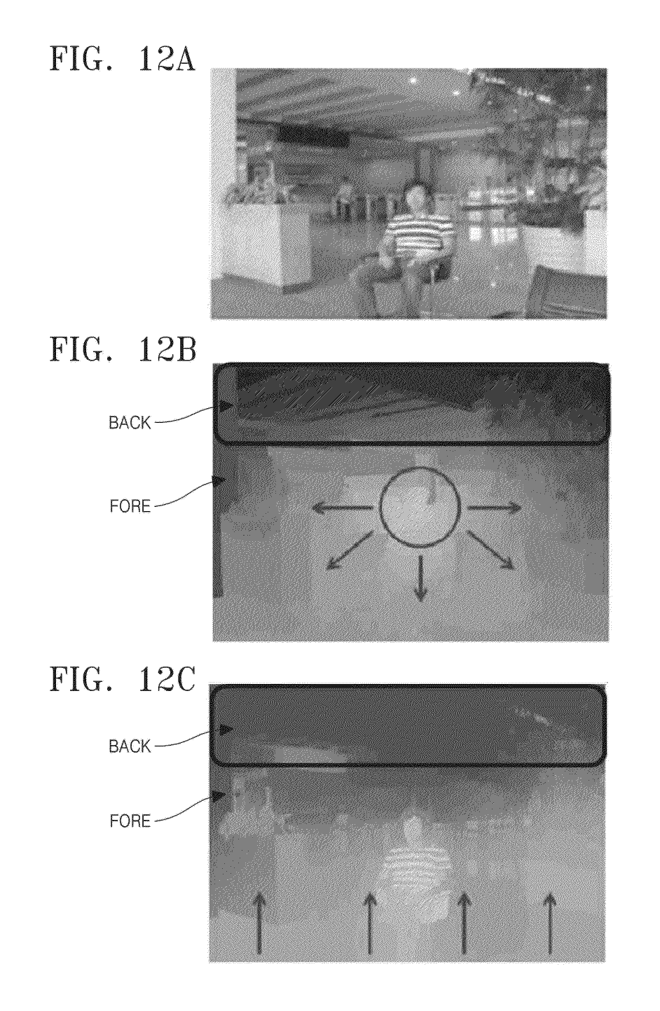

FIGS. 12A through 12C illustrate examples of estimated depth data EZD provided by the transformation unit 22 of FIG. 11, according to an embodiment of the inventive concept. More particularly, FIG. 12A illustrates an original 2D color image. FIG. 12B illustrates an example of estimated depth data EZD, which is provided by the transformation unit 22, of the original image of FIG. 12A. FIG. 12C illustrates another example of estimated depth data EZD, which is provided by the transformation unit 22, of the original image of FIG. 12A.

Referring to FIG. 12B, the second segmentation unit 221 extracts a foreground FORE and a background BACK through subject segmentation from an image, and then divides the foreground FORE into multiple segments. The indexing unit 222 indexes relative depths of the segments in directions from the center toward edges of the foreground FORE, as indicated by arrows in FIG. 12B, based on the initial depth data IZD. The DM generating unit 223 generates a DM from the indexed depths of the segments, and the estimated depth providing unit 224 provides an image including the estimated depth data EZD based on the DM as shown in FIG. 12B.

Referring to FIG. 12C, the second segmentation unit 221 extracts a foreground FORE and a background BACK through subject segmentation from an image, and then divides the foreground FORE into multiple segments. The indexing unit 222 indexes relative depths of the segments in directions from the bottom toward the top of the foreground FORE, as indicated by arrows in FIG. 12C, based on the initial depth data IZD. The DM generating unit 223 generates a DM from the indexed depths of the segments, and the estimated depth providing unit 224 provides an image including the estimated depth data based on the DM as shown in FIG. 12C.

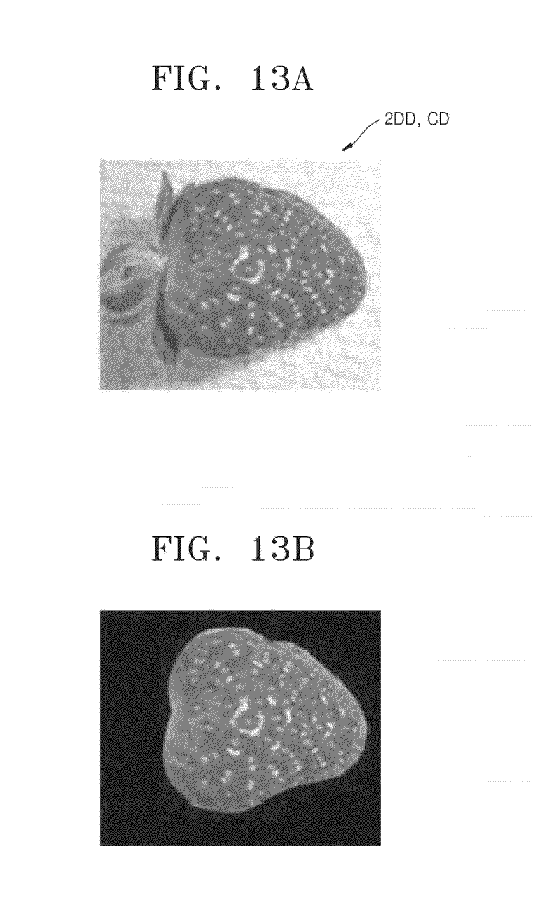

FIGS. 13A through 13D are examples of images illustrating results output from elements included in the transformation unit 22 of FIG. 11, according to an embodiment of the inventive concept. FIG. 13A, in particular, illustrates results output from the elements included in the transformation unit 22 when a patterned texture is used as a depth cue.

Referring to FIGS. 13A through 13D, the second segmentation unit 221 receives an original image, such as the 2D image data 2DD (e.g., in FIG. 2) or the color data CD (e.g., in FIGS. 7 and 9) illustrated in FIG. 13A, and provides a texture area obtained as shown in FIG. 13B by using the patterned texture as a depth cue. The second segmentation unit 221 may determine a body of a main subject, that is, a strawberry, as a foreground and an area excluding the body of the main subject as a background. The DM generating unit 223 generates a DM as shown in FIG. 13C. The estimated depth providing unit 224 provides the estimated depth data EZD as shown in FIG. 13D.

Accordingly, the transformation unit 22 provides the estimated depth data EZD by transforming the 2D image data 2DD (or the color data CD) into 3D data using a patterned texture as a depth cue. However, although the transformation unit 22 exemplarily transforms 2D image data into 3D data using a patterned texture as a depth cue, the inventive concept is not limited thereto and the transformation unit 22 may transform 2DD image data into 3D data using any of various depth cues as described above.

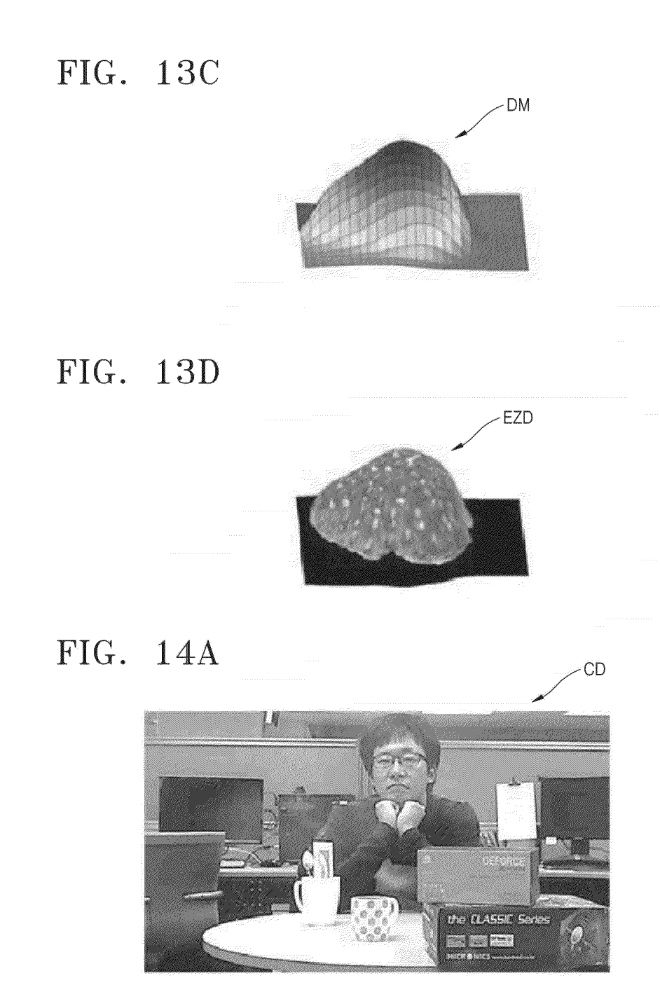

FIGS. 14A through 14D are images for explaining operation of the final depth providing unit 20 of the apparatus 1 of FIG. 2, according to an embodiment of the inventive concept.

Referring to FIGS. 2 and 14A through 14D, the sensing unit 10 provides the color data CD as shown in FIG. 14A and the initial depth data IZD as shown in FIG. 14C based on light received from the subject group 2. According to the initial depth data IZD, a portion of a background BACK excluding a main subject appears to have the same depth as that of a foreground FORE including the main subject. This is due to depth folding, as described above. The sensing unit 10 may determine that a subject located beyond a maximum distance is located closer than where it is actually located.

The first segmentation unit 21 classifies an image obtained from the subject group 2 into first and second areas, for example, a foreground FORE and a background BACK. The transformation unit 22 provides the estimated depth data EZD as shown in FIG. 14B by transforming the color data CD as shown in FIG. 14A into 3D data. The estimated depth data EZD may be generated irrespective of a distance between the sensing unit 10 and a subject.

The first extraction unit 231 extracts a portion corresponding to the foreground FORE in the initial depth data IZD, that is, the image as shown in FIG. 14C, as the first data ZD1. Also, the second extraction unit 232 may extract a portion corresponding to the background BACK in the estimated depth data EZD, that is, the image as shown in FIG. 14B, as the second data ZD2. The combining unit 24 provides the final depth data FZD as shown in FIG. 14D by combining the first data ZD1 with the second data ZD2.

When the initial depth data IZD illustrated in FIG. 14C and the final depth data FZD illustrated in FIG. 14D are compared with each other, it is found that the final depth data FZD has depth information with greater accuracy and realistic visual effect than the initial depth data IZD. As such, according to the present embodiment, since the initial depth data IZD is used for a foreground and the estimated depth data EZD is used for a background, the final depth data FZD having depth information with greater accuracy and realistic visual effect through correction than the initial depth data IZD may be provided.

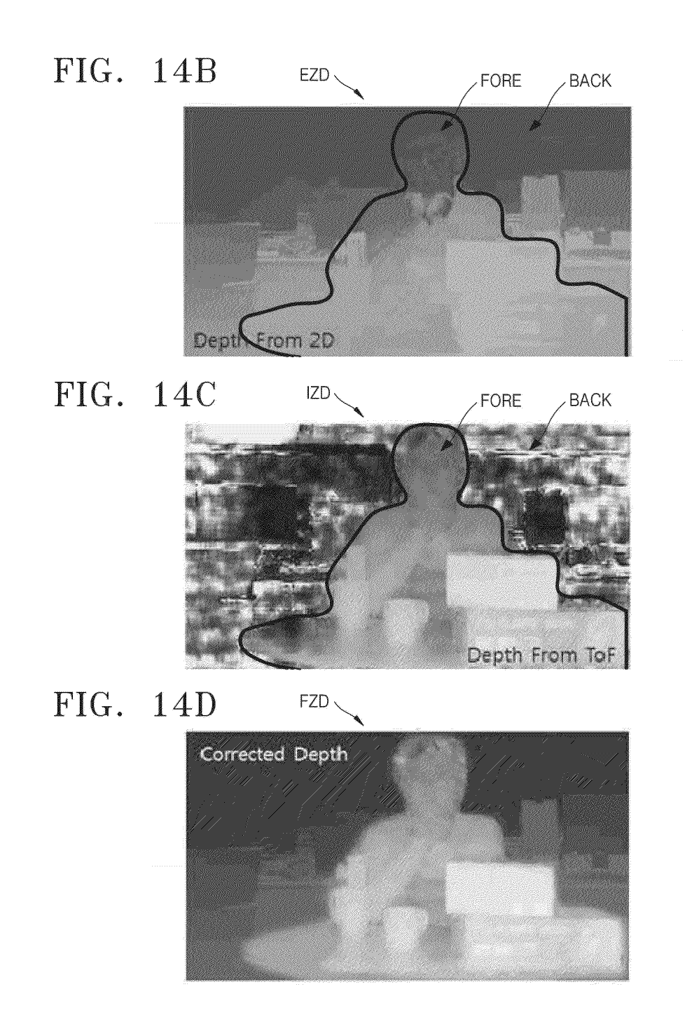

FIG. 15 is a flowchart illustrating a method of generating depth information, according to an embodiment of the inventive concept.

Referring to FIG. 15, the method includes operations which are performed by any of the apparatuses 1 and 1A illustrated in FIGS. 1, 2, 4, and 5, for example. Accordingly, although omitted, the description made with reference to any of the apparatuses 1 and 1A of FIGS. 1, 2, 4, and 5 will apply to the method of FIG. 15.

In operation S100, the light source 30 emits the light EL to multiple subjects, such as the first through third subjects SUB1, SUB2, and SUB3. In operation S110, the lens unit 40 concentrates the reflected light RL received from the first through third subjects SUB1, SUB2, and SUB3 onto the sensing unit 10. In operation S120, the depth sensor 11a provides the initial depth data IZD having distance information about the first through third subjects SUB1, SUB2, and SUB3 and the intensity data INT of the first through third subjects SUB1, SUB2, and SUB3 by sensing the reflected light RL received from the first through third subjects SUB1, SUB2, and SUB3.

In operation S130, the first segmentation unit 21 divides an image into multiple segments, and classifies the segments into the first area AREA1 and the second area AREA2 based on the initial depth data IZD. In operation S140, the transformation unit 22a generates the estimated depth data EZD by transforming the intensity data INT into 3D data.

In operation S150, the first extraction unit 231 extracts the first data ZD1 corresponding to the first area AREA1 from the initial depth data IZD. In operation S160, the second extraction unit 232 extracts the second data ZD2 corresponding to the second area AREA2 from the estimated depth data EZD. In operation S170, the combining unit 24 provides the final depth data FZD by combining the first data ZD1 with the second data ZD2.

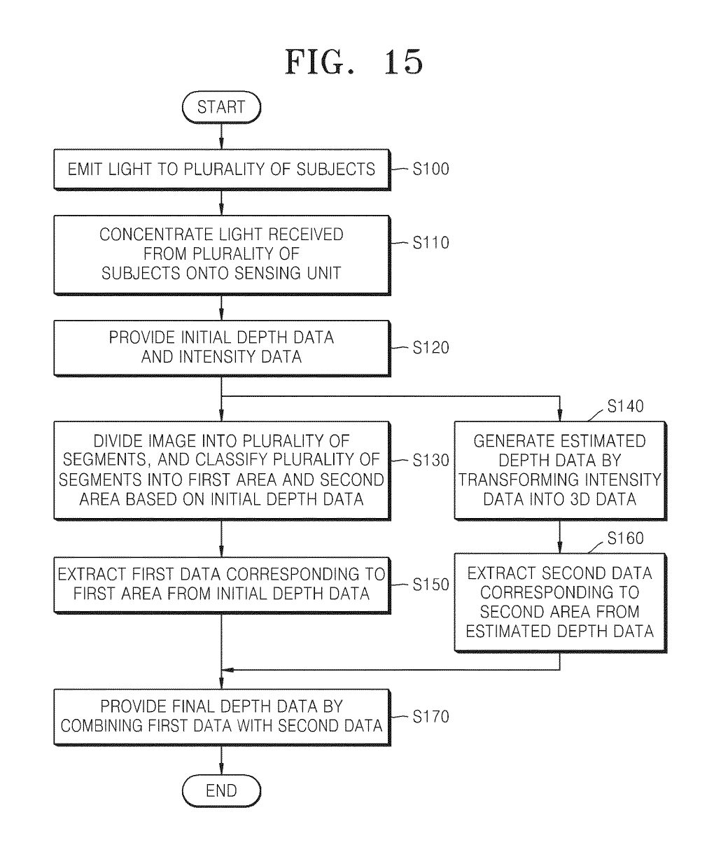

FIG. 16 is a flowchart illustrating a method of generating depth information, according to another embodiment of the inventive concept.

Referring to FIG. 16, the method includes operations which are performed by any of the apparatuses 1 and 1B illustrated in FIGS. 1, 2, 7 and 8, for example. Accordingly, although omitted, the description made with reference to any of the apparatuses 1 and 1B of FIGS. 1, 2, 7 and 8 will apply to the method of FIG. 16.

In operation S200, the light source 30 emits the light EL to multiple subjects, such as the first through third subjects SUB1, SUB2, and SUB3. In operation S210, the lens unit 40 concentrates the reflected light RL received from the first through third subjects SUB1, SUB2, and SUB3 onto the sensing unit 10.

In operation S220, the depth sensor 11a provides the initial depth data IZD having distance information about the first through third subjects SUB1, SUB2, and SUB3 and the intensity data INT of the first through third subjects SUB1, SUB2, and SUB3 by sensing the reflected light RL received from the first through third subjects SUB1, SUB2, and SUB3. In operation S230, the color sensor 11b provides the color data CD of the first through third subjects SUB1, SUB2, and SUB3 by sensing the visible light VL received from the first through third subjects SUB1, SUB2, and SUB3.

In operation S240, the first segmentation unit 21 divides an image into multiple segments, and classifies the segments into a first area and a second area based on the initial depth data IZD. In operation S250, the transformation unit 22b generates the estimated depth data EZD by transforming the color data CD into 3D data.

In operation S260, the first extraction unit 231 extracts first data corresponding to the first area from the initial depth data IZD. In operation S270, the second extraction unit 232 extracts second data corresponding to the second area from the estimated depth data EZD. In operation S280, the combining unit 24 provides the final depth data FZD by combining the first data with the second data.

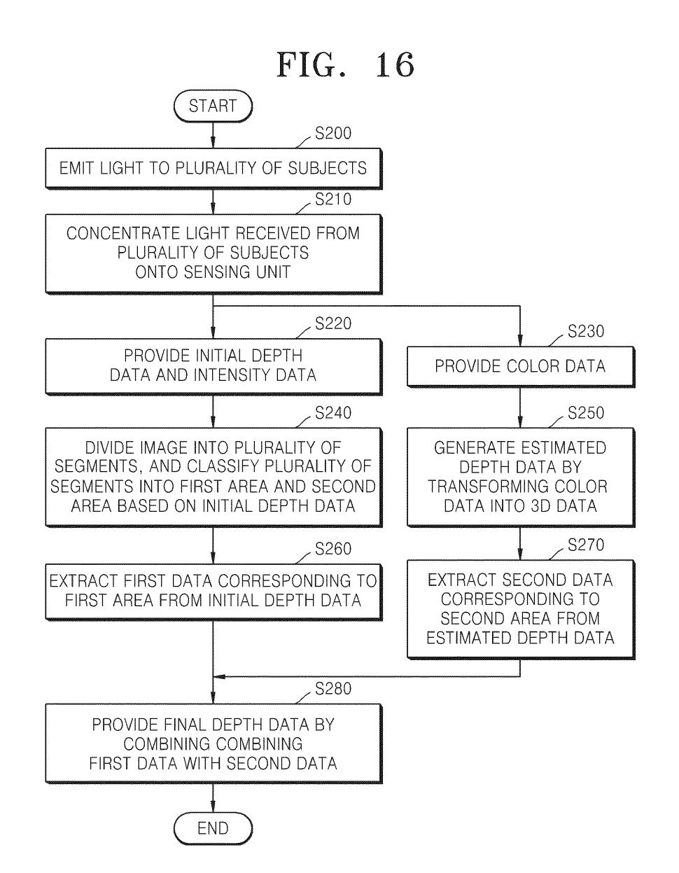

FIG. 17 is a flowchart illustrating a method of generating depth information, according to another embodiment of the inventive concept.

Referring to FIG. 17, the method includes operations which are performed by any of the apparatuses 1 and 1C of FIGS. 1, 2, 9, and 10, for example. Accordingly, although omitted, the description made with reference to any of the apparatuses 1 and 1C of FIGS. 1, 2, 9, and 10 will apply to the method of FIG. 17.

In operation S300, the light source 30 emits the light EL to multiple subjects, such as the first through third subjects SUB1, SUB2, and SUB3. In operation S310, the lens unit 40 concentrates the reflected light RL received from the first through third subjects SUB1, SUB2, and SUB3 onto the sensing unit 10. In operation S320, the depth/color sensor 11c provides the initial depth data IZD having distance information about the first through third subjects SUB1, SUB2, and SUB3 and the intensity data INT of the first through third subjects SUB1, SUB2, and SUB3 by sensing the reflected light RL received from the first through third subjects SUB1, SUB2, and SUB3. The depth/color sensor 11c also provides the color data CD of the first through third subjects SUB1, SUB2, and SUB3 by sensing the visible light VL received from the first through third subjects SUB1, SUB2, and SUB3.

In operation S330, the first segmentation unit 21 divides an image into multiple segments, and classifies the segments into a first area and a second area based on the initial depth data IZD. In operation S340, the transformation unit 22b generates the estimated depth data EZD by transforming the color data CD into 3D data.

In operation S350, the first extraction unit 231 extracts first data corresponding to the first area from the initial depth data IZD. In operation S360, the second extraction unit 232 extracts second data corresponding to the second area from the estimated depth data EZD. In operation S370, the combining unit 24 provides the final depth data FZD by combining the first data with the second data.

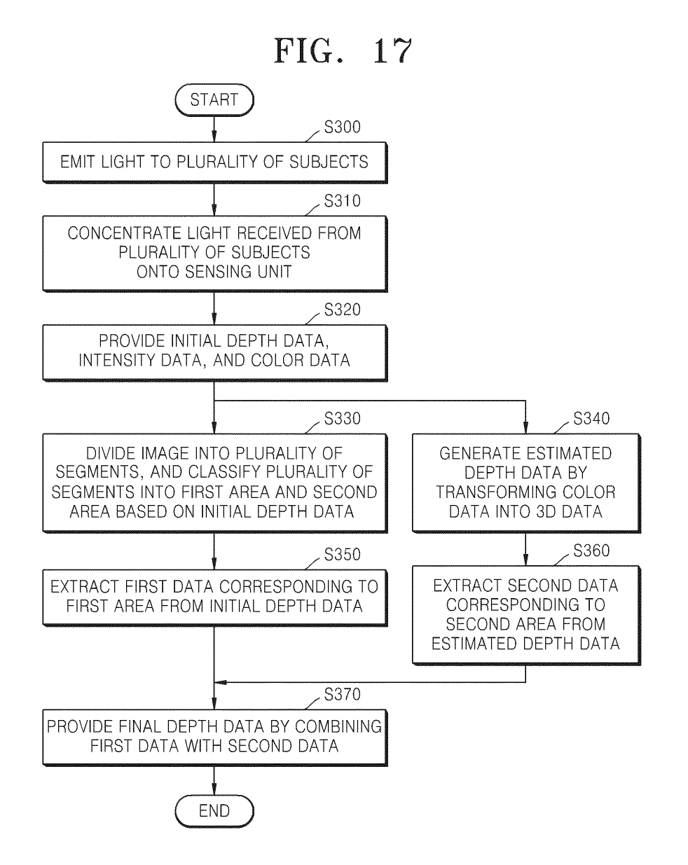

FIG. 18 is a block diagram illustrating a photographing apparatus 1000 using an apparatus for generating depth information, according to an embodiment of the inventive concept.

Referring to FIG. 18, the photographing apparatus 1000, which may be a camera, for example, includes an image sensor 1100 and a processor 1200. The processor 1200 may be a microprocessor, an image processor, or any of other type of control circuits, such as an application-specific integrated circuit (ASIC), for example. The image sensor 1100 and the processor 1200 may be constructed as individual integrated circuits. Alternatively, the image sensor 1100 and the processor 1200 may be constructed on the same integrated circuit.

The image sensor 1100, which is a semiconductor device for converting an optical image into an electrical signal, may include any of the apparatuses 1, 1A, 1B, and 1C as described above with reference to FIGS. 1 through 17. Accordingly, the image sensor 1100 may include the sensing unit 10 and the final depth providing unit 20, for example. The sensing unit 10 provides initial depth data having distance information about multiple subjects and 2D image data having 2D image information about an image obtained from the subjects by sensing light received from the subjects, that is, reflected light and/or visible light. The final depth providing unit 20 generates estimated depth data having estimated distance information about the subjects by transforming the 2D image data into 3D data, and provides final depth data based on the initial depth data and the estimated depth data.

The processor 1200 includes an image signal processing (ISP) unit 1210, a control unit 1220, and an interface unit 1230. The ISP unit 1210 performs signal processing of received image data including final distance data output from the image sensor 1100. The control unit 1220 outputs a control signal to the image sensor 1100. The interface unit 1230 may transmit the image data on which image processing is performed to a display 1500 to be reproduced by the display 1500.

In FIG. 18, the photographing apparatus 1000 may be connected to the display 1500. Alternatively, the photographing apparatus 1000 and the display 1500 may be integrally constructed.

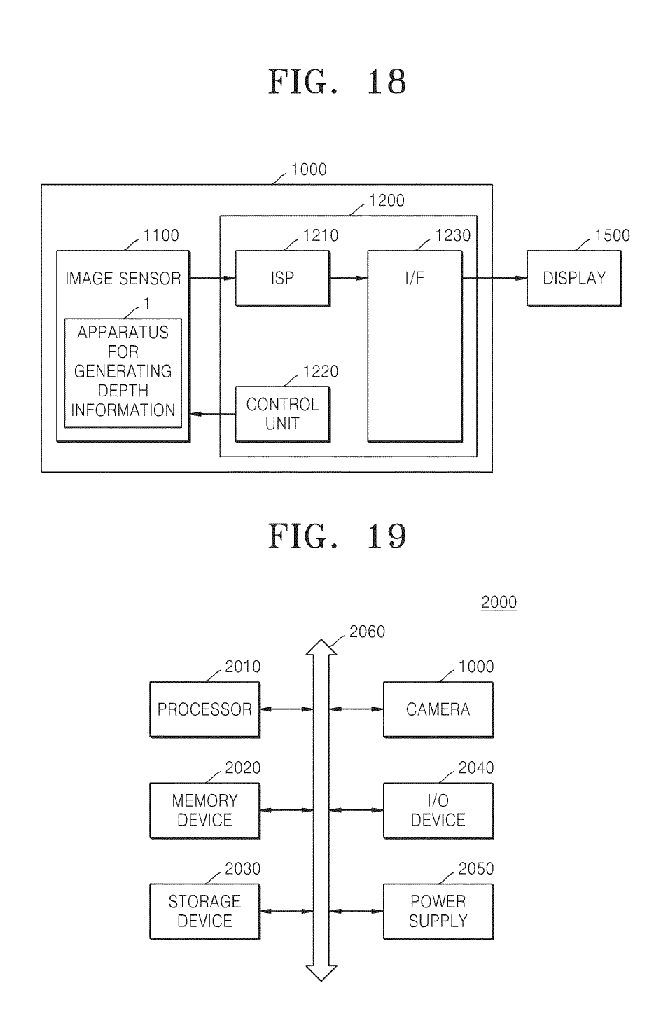

FIG. 19 is a block diagram illustrating a computing system 2000 including the photographing apparatus 1000 of FIG. 18, according to an embodiment of the inventive concept.

Referring to FIG. 19, the computing system 2000 includes a processor 2010, a memory device 2020, a storage device 2030, an input/output (I/O) device 2040, a power supply 2050, and a camera 1000 (which may be embodied as the photographing device 1000 of FIG. 18). Although not shown in FIG. 19, the computing system 2000 may further include ports that may communicate with a video card, a sound card, a memory card, or a universal serial bus (USB), and/or other electronic devices.

The processor 2010 may perform specific arithmetic operations or tasks. According to various embodiments, the processor 2010 may be a microprocessor or a central processing unit (CPU), for example. The processor 2010 communicates with the memory device 2020, the storage device 2030, and the I/O device 2040 via a bus 2060, such as an address bus, a control bus, or a data bus. According to various embodiments, the processor 2010 may be connected to an extended bus, such as a peripheral component interconnect (PCI) bus, for example.

The memory device 2020 may store data needed to operate the computing system 2000. For example, the memory device 2020 may be a dynamic random-access memory (DRAM), a mobile DRAM, a static random-access memory (SRAM), a phase-change random-access memory (PRAM), a ferroelectric random-access memory (FRAM), a resistive random-access memory (RRAM), and/or a magnetoresistive random-access memory (MRAM), for example. Examples of the storage device 2030 include a solid state drive, a hard disk drive, and a compact disk read-only memory (CD-ROM).

The I/O device 2040 may include an input unit, such as a keyboard, a keypad, or a mouse, and an output unit, such as a printer or a display. The power supply 2050 may apply a voltage needed to operate the computing system 2000.

The camera 1000 may be connected to the processor 2010 via the bus 2060 or another communication link to communicate with the processor 2010. As described above, the camera 1000 may provide initial depth data having distance information about multiple subjects and 2D image data having 2D image information about an image obtained from the subjects by sensing reflected light received from the subjects. The camera 1000 may then generate estimated depth data having estimated distance information about the subjects by transforming the 2D image data into 3D data, and provide final depth data based on the initial depth data and the estimated depth data.

The camera 1000 may be packed in any of various types of packages. For example, at least some elements of the photographing apparatus 1000 may be packaged in any of packages, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flatpack (TQFP), small outline (SOIC), shrink small outline package (SSOP), thin small outline (TSOP), thin quad flatpack (TQFP), system in package (SIP), multi chip package (MCP), wafer-level fabricated package (WFP), and wafer-level processed stack package (WSP), for example.

Meanwhile, the computing system 2000 may be any computing system using a photographing apparatus. Examples of the computing system 2000 include a digital camera, a mobile phone, a persona digital assistant (PDA), a portable multimedia player (PMP) and a smart phone.

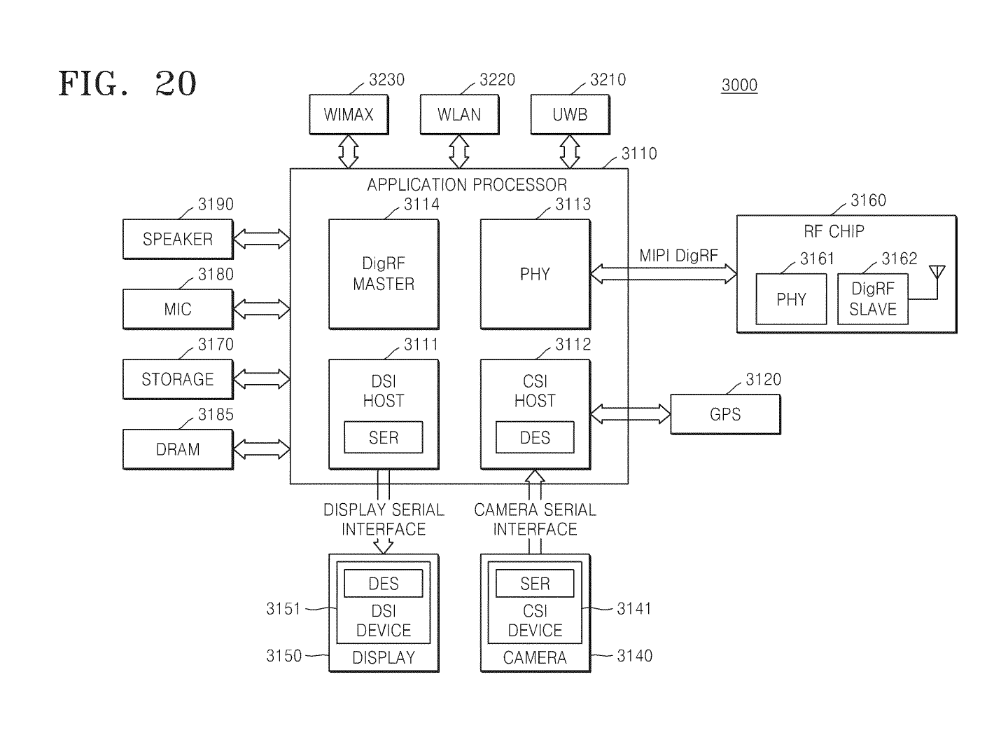

FIG. 20 is a block diagram illustrating an interface used in the computing system 2000 of FIG. 19, according to an embodiment of the inventive concept.

Referring to FIG. 20, a computing system 3000, which is a data processing device that uses or supports a mobile industry processor interface (MIPI), includes an application processor 3110, a photographing apparatus 3140, and a display 3150. A camera serial interface (CSI) host 3112 of the application processor 3110 may perform serial communication with a CSI device 3141 of the photographing apparatus 3140 via a CSI.

The CSI host 3112 includes a deserializer DES, and the CSI device 3141 includes a serializer SER. A display serial interface (DSI) host 3111 of the application processor 3110 performs serial communication with a DSI device 3151 of the display 3150 via a DSI.

The DSI host 3111 includes a serializer SER, and the DSI device 3151 may include a deserializer DES. Furthermore, the computing system 3000 further includes a radio-frequency (RF) chip 3160 that communicates with the application processor 3110. A physical layer (PHY) 3113 of the computing system 3000 and a PHY 3161 of the RF chip 3160 may transmit and receive data therebetween according to MIPI DigRF. Also, the application processor 3110 further includes a DigRF master 3114 that controls data transmission/reception according to MIPI DigRF of the PHY 3161.

The computing system 3000 may include a global positioning system (GPS) 3120, a storage unit 3170, a microphone 3180, a DRAM 3185, and a speaker 3190. Also, the computing system 3000 may perform communication by using an ultra-wideband (UWB) 3210, a wireless local area network (WLAN) 3220, and worldwide interoperability for microwave access (WiMAX) 3230. However, an interface and a structure of the computing system 3000 shown are merely exemplarily and the embodiments of the inventive concept are not limited thereto.

According to embodiments of an apparatus for generating depth information, since final depth data is generated based on initial depth data, and estimated depth data is generated from 2D image data, final depth data is generated with greater accuracy and realistic visual effect through correction than the initial depth. More particularly, initial depth data is extracted as data corresponding to an area having a relatively small distance from subjects, estimated depth data is extracted as data corresponding to an area having a relatively large distance from the subjects, and the initial depth data and the estimated depth data are combined with each other in order to generate final depth data having greater accuracy and realistic visual effect.

While the inventive concept has been described with reference to exemplary embodiments, it will be apparent to those skilled in the art that various changes and modifications may be made without departing from the spirit and scope of the present inventive concept. Therefore, it should be understood that the above embodiments are not limiting, but illustrative.

1. An apparatus for generating depth information from an image, the apparatus comprising:
a sensing unit configured to sense light received from a plurality of subjects, and to provide initial depth data having distance information about the plurality of subjects and two-dimensional (2D) image data having 2D image information about an image obtained from the plurality of subjects; and
a final depth providing unit configured to generate estimated depth data having estimated distance information about the plurality of subjects by transforming the 2D image data into three-dimensional (3D) data, and to provide final depth data based on the initial depth data and the estimated depth data.

2. The apparatus of claim 1, wherein the final depth providing unit is further configured to divide the image into a first area and a second area, and to provide the final depth data by combining the initial depth data of the first area with the estimated depth data of the second area.

3. The apparatus of claim 2, wherein the first area comprises a foreground of at least one main subject from among the plurality of subjects, and
the second area comprises a background excluding the at least one main subject from among the plurality of subjects.

4. The apparatus of claim 1, wherein the final depth providing unit comprises:
a first segmentation unit configured to divide the image into a plurality of segments, and to classify the plurality of segments into a first area and a second area based on the initial depth data;
a transformation unit configured to generate the estimated depth data by transforming the 2D image data into the 3D data;
an extraction unit configured to extract first data corresponding to the first area from the initial depth data, and to extract second data corresponding to the second area from the estimated depth data; and
a combining unit configured to provide the final depth data by combining the first data with the second data.

5. The apparatus of claim 4, wherein the transformation unit comprises:
a second segmentation unit configured to divide the image into a plurality of segments based on a depth cue in the image;
an indexing unit configured to index depths of the plurality of segments based on the initial depth data; and
a depth map generating unit configured to generate a depth map from the indexed depths of the plurality of segments.

6. The apparatus of claim 5, wherein the transformation unit further comprises an estimated depth providing unit configured to provide the estimated depth data that is the 3D data based on the depth map.

7. The apparatus of claim 1, wherein the 2D image data comprises at least one of intensity data and color data.

8. The apparatus of claim 1, wherein the sensing unit comprises a depth sensor configured to generate the initial depth data and intensity data based on reflected light received from the plurality of subjects.

9. The apparatus of claim 1, wherein the sensing unit comprises:
a depth sensor configured to generate the initial depth data and intensity data based on reflected light received from the plurality of subjects; and
a color sensor configured to generate color data based on visible light received from the plurality of subjects.

10. The apparatus of claim 1, wherein the sensing unit comprises a depth/color sensor configured to simultaneously generate the initial depth data, intensity data, and color data based on reflected light and visible light received from the plurality of subjects.

11. The apparatus of claim 1, wherein the sensing unit comprises a time-of-flight (ToF) sensor for providing the initial depth data.

12. A photographing apparatus, comprising:
an image sensor; and
a processor,
wherein the image sensor comprises:
a sensing unit configured to sense light received from a plurality of subjects, and to provide initial depth data having distance information about the plurality of subjects and two-dimensional (2D) image data having 2D image information about an image obtained from the plurality of subjects; and
a final depth providing unit configured to generate estimated depth data having estimated distance information about the plurality of subjects by transforming the 2D image data into three-dimensional (3D) data, and to provide final depth data based on the initial depth data and the estimated depth data.

13. The photographing apparatus of claim 12, wherein the final depth providing unit is further configured to divide the image into a first area and a second area, and to provide the final depth data by combining the initial depth data of the first area with the estimated depth data of the second area.

14. The photographing apparatus of claim 12, wherein the final depth providing unit comprises:
a first segmentation unit configured to divide the image into a plurality of segments, and to classify the plurality of segments into a first area and a second area based on the initial depth data;
a transformation unit configured to generate the estimated depth data by transforming the 2D image data into 3D data;
an extracting unit configured to extract first data corresponding to the first area from the initial depth data, and to extract second data corresponding to the second area from the estimated depth data; and
a combining unit configured to provide the final depth data by combining the first data with the second data.

15. The photographing apparatus of claim 12, wherein the 2D image data comprises at least one of intensity data and color data.

16-20. (canceled)
